(19) United States
(12) Patent Application Publication
(10) Pub. No.: US 2020/0254370 A1
(43) Pub. Date: Aug. 13, 2020

(54) SYSTEMS AND METHODS FOR INTEGRATION OF PRESSURE DIFFERENTIAL SENSOR

(71) Applicant: Cummins Filtration IP, Inc., Columbus (IN)

(72) Inventors: Hariprasad M. Bhalerao, Pune (IN); Amit S. Wankhede, Pune (IN); Shrikant A. Kamble, Pune (IN); Shubha Agrawal, JAIPUR (IN)

(73) Assignee: Cummins Filtration IP, Inc, Columbus (IN)

(21) Appl. No.: 15/774,364

(22) PCT Filed: Nov. 9, 2016
(86) PCT No.: PCT/US2016/061146

§ 371 Date: May 8, 2018

Related U.S. Application Data
(60) Provisional application No. 62/253,297, filed on Nov. 10, 2015.

(51) Int. Cl. B01D 35/30; G01L 13/00; B01D 37/04; B01D 35/147; B01D 35/00; F02M 37/32

(52) U.S. Cl. CPC B01D 35/306; G01L 13/00; B01D 37/046; B01D 2201/0453; B01D 35/005; F02M 37/32; B01D 2201/4092; B01D 35/147

(57) ABSTRACT

Filtration systems having a pressure differential sensor mounted on a bottom side of the filter housing are described. The pressure differential sensor engages with the removable filter cartridge to provide a seal between the clean side and the dirty side of the filter media when the removable filter cartridge is received within this housing. The pressure differential sensor is positioned such that it measures a pressure differential across only the removable filter cartridge.

### CROSS-REFERENCE TO RELATED APPLICATIONS

This application is related and claims priority to U.S. Provisional Patent Application No. 62/253,297, entitled “SYSTEMS AND METHODS FOR INTEGRATION OF PRESSURE DIFFERENTIAL SENSOR,” by Bhalerao et al., filed on Nov. 10, 2015, which is herein incorporated by reference in its entirety and for all purposes.

### TECHNICAL FIELD

The present application relates to filtration systems.

### BACKGROUND

During operation of an internal combustion engine, various gases and liquids pass through filter filtration systems to remove contaminants (e.g., dust, water, oil, etc.) from the fluid. The filtration systems include filter elements having filter media. As the fluid passes through the filter media, the filter media removes at least a portion of the contaminants in the fluid. As the filter media removes the contaminants, the restriction of the filter media increases.

As the restriction of the filter media increases, the pressure drop across the filtration system increases. If the pressure drop becomes too high, the internal combustion engine may not receive enough filtered fluid to function properly. Accordingly, once the filter media's restriction has reached a threshold level, the filter element needs to be replaced with a replacement filter element having replacement filter media.

Many filtration systems utilize pressure differential (dP) sensors to measure the pressure drop across the filtration system. A dP sensor is single sensor arrangement, which may be made up of two different pressure sensors, measures an upstream fluid pressure and a downstream fluid pressure to determine a dP between the upstream and downstream pressures. When the dP reaches a threshold level as measured by the dP sensor, the engine control unit (ECU) can trigger an alert to an operator to replace the associated filter element. In existing filtration system designs, the dP sensor is mounted over a filter head of the filtration system.

However, the placement of the dP sensor in the filter head measures a pressure drop across components other than the filter media. Additionally, the placement of the dP sensor in the filter head does not prevent unauthorized replacement filter elements from being installed into the filtration systems, which may damage the filtration systems of the internal combustion engine.

### SUMMARY

Various example arrangements relate to filtration systems having a dP sensor mounted on a bottom side of the filter housing. One such arrangement relates to a filtration system. The filtration system includes a filter head having an inlet and an outlet. The filtration system further includes a filter housing removably connected to the filter head and defining a filter compartment. The filtration system includes a filter element positioned in the filter compartment. The filter element has a first endplate, a second endplate, and filter media positioned between the first endcap and the second endcap. The filtration system further includes a pressure differential sensor positioned at a location of the filter housing substantially opposite the filter head. The pressure differential sensor extends into an interior of the filter element.

Another example arrangement relates to a filter element. The filter element includes a first endplate and a second endplate displaced from the first endplate. The second endplate has an opening configured to receive a sensor housing and a pressure differential sensor of a filtration system such that the sensor housing extends into the filter element when the filter element is installed in the filtration system. The filter element further includes filter media positioned between the first endplate and the second endplate. The first endplate and the second endplate seal a clean side of the filter media from a dirty side of the filter media.

A further example arrangement relates to a method. The method includes inserting a sensor into a lower portion of a sensor housing. The method further includes providing an upper portion of the sensor housing over the sensor. The method includes installing an upper seal over the upper portion of the sensor housing. The method further includes installing the sensor and the sensor housing in a filter housing via a first threaded connection. The method includes installing a filter element in the filter housing such that the upper portion of the sensor housing extends into the filter element.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a cross-sectional view of a filtration system according to an example embodiment.

FIG. 2 is a close-up cross-sectional view of the dP sensor of the filtration system of FIG. 1.

FIGS. 3 and 4 are cross-sectional vies of a filtration system according to another example embodiment.

FIGS. 5A through 5D show cross-sectional views demonstrating the installation of a dP sensor to a filter housing of a filtration system according to an example embodiment.

### DETAILED DESCRIPTION

Referring to the figures generally, filtration systems having a dP sensor mounted on a bottom side of the filter housing are described. The dP sensor engages with the removable filter cartridge to provide a seal between the clean side and the dirty side of the filter media when the removable filter cartridge is received within this housing. The dP sensor is positioned such that the dP sensor measures a dP across only the removable filter cartridge. The positioning of the dP sensor also prevents certain unauthorized filter elements from being installed in the filtration system. Accordingly, the positioning of the dP sensor functions as an engine integrity protection (EIP) feature.

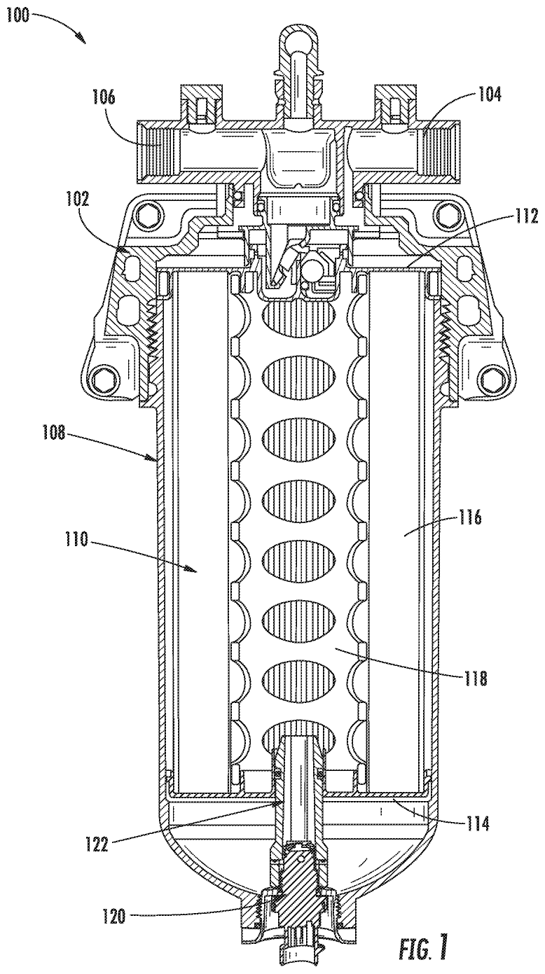

Referring to FIG. 1, a cross-sectional view of a filtration system 100 is shown according to an example embodiment. The filtration system includes a filter head 102 having an inlet 104 and an outlet 106. The inlet 104 receives a fluid to be filtered, such as oil, fuel, water, or the like. The outlet 106 provides filtered fluid to a device, such as an internal combustion engine (e.g., a diesel internal combustion engine). The filtration system includes a filter housing 108 removably connected to the filter head 102. In some arrangements, the filter housing 108 is removably connected to the filter head 102 via a threaded connection. In such arrangements, the filter housing 108 is a spin-on type filter housing. The filter housing 108, in the embodiment of FIG. 1 comprises a cylindrical shell housing that forms and defines a filter compartment that receives a filter element 110.

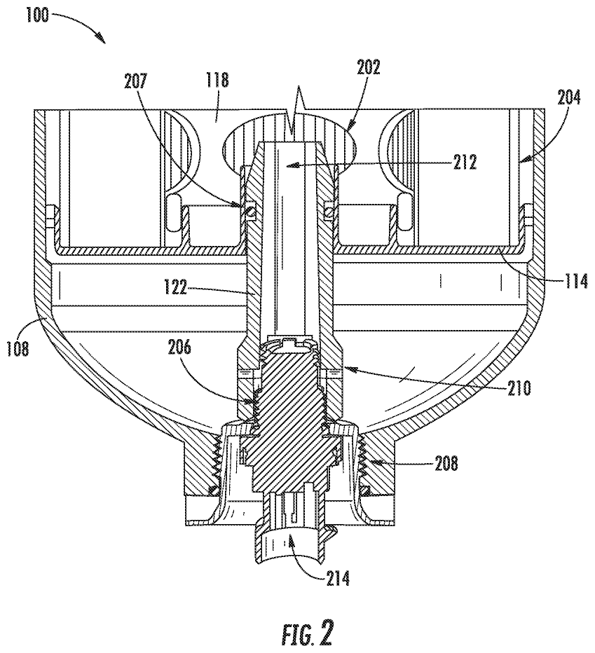

In FIG. 1, the filter element 110 is in an installed position within the filtration system 100. The filter element 110 is removable from the filter housing 108 when the filter housing 108 is removed from the filter head 102. The filter element 110 includes a first endplate 112 and a second endplate 114 displaced from the first endplate 112. Filter media 116 is positioned between the first endplate 112 and the second endplate 114. The first endplate 112 and the second endplate 114 seal a clean side 202 (as shown in FIG. 2) of the filter media 116 from a dirty side 204 (as shown in FIG. 2) of the filter media 116. In some arrangements, the filter element 110 includes a central support tube 118 that connects the first endplate 112 and the second endplate 114. The central support tube 118 helps to prevent the filter media 116 from collapsing during filtration of the fluid.

The filtration system 100 includes a dP sensor 120 positioned at a bottom of the filter housing 108. The dP sensor may be a single sensor, or the DP sensor may comprise two separate pressure sensors (each of which measures the pressure at a specific location). The bottom of the filter housing 108 is opposite the portion of the filter housing 108 that engages with the filter head 102. The dP sensor 120 is received within a dP sensor housing 122. In some arrangements, the dP sensor housing 122 includes a top portion and a bottom portion. A close-up cross-sectional view of the dP sensor 120 and the dP sensor housing 122 is shown in FIG. 2. As shown in FIG. 2, the dP sensor 120 is coupled to the dP sensor housing 122 through a threaded connection 206. The threaded connection 206 retains the dP sensor 120 within a cavity of the dP sensor housing 122. The dP sensor housing 122 has an externally threaded portion that forms a threaded connection 208 with the bottom of the filter housing 108. Accordingly, the dP sensor housing 122 can be removed from the filter housing 108, and the dP sensor 120 can be removed from the dP sensor housing 122. When coupled to the filter housing 108, the dP sensor housing 122 extends from the bottom of the filter housing 108 and into an opening in the second endplate 114 of the filter element 110. The dP sensor housing 122 includes a seal 207 that forms a seal between the second endplate 114 and the dP sensor housing 122, thereby sealing the clean side 202 from the dirty side 204. In some arrangements, the seal 207 comprises an o-ring. The positioning of the dP sensor 120 at the bottom of the filter housing 108 and within the dP sensor housing 122 protects the dP sensor 120 and reduces the risk of damage during packaging, handling, and operation of the filtration system 100.

The dP sensor 120 senses two fluid pressures within the filter housing 108. The dP sensor housing 122 has a first opening 210 on the dirty side 204 of the filter media 116. The first opening 210 is in fluid communication with the dP sensor 120 and allows the fluid within the filter housing 108 on the dirty side 204 to reach the dP sensor 120. The dP sensor housing 122 has a second opening 212 on the clean side 202 of the filter media 116. The second opening 212 is in fluid communication with the dP sensor 120 and allows the fluid within the filter housing 108 on the clean side 202 to reach the dP sensor 120. The dP sensor 120 senses the two fluid pressures at the two locations and determines a dP between the clean side 202 (i.e., the second opening 212) and the dirty side 204 (i.e., the first opening 210). The determined dP is provided as a feedback signal to an external electronic device, such as the ECU of the internal combustion engine, through the electrical connection 214. The positioning of the dP sensor 120 on the bottom of the filter housing 108 provides for an easy connection with the ECU. The positioning of the dP sensor 120 and the arrangement of the dP sensor housing 122 ensures that the dP sensor 122 measures a dP across only the filter element 110, which eliminates the need to calibrate the sensor to account for the dP across other components that is typical when placing a dP sensor in the filter head. In some arrangements, the dP sensor 120 and the dP sensor housing 122 is combined with a drain valve (e.g., a water drain valve in arrangements where the filtration system is a fuel filtration system that separates water from fuel). In such arrangements, the integration reduces overall part count.

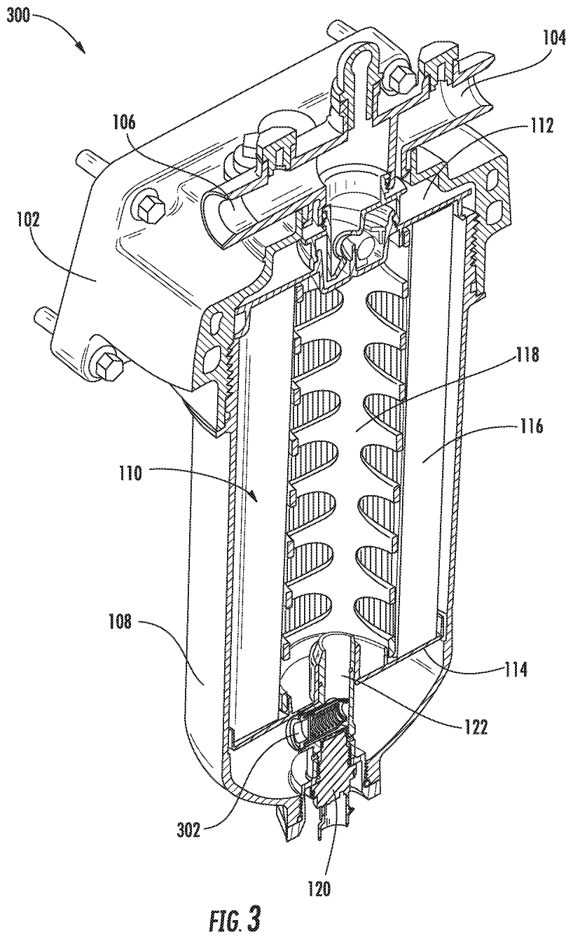

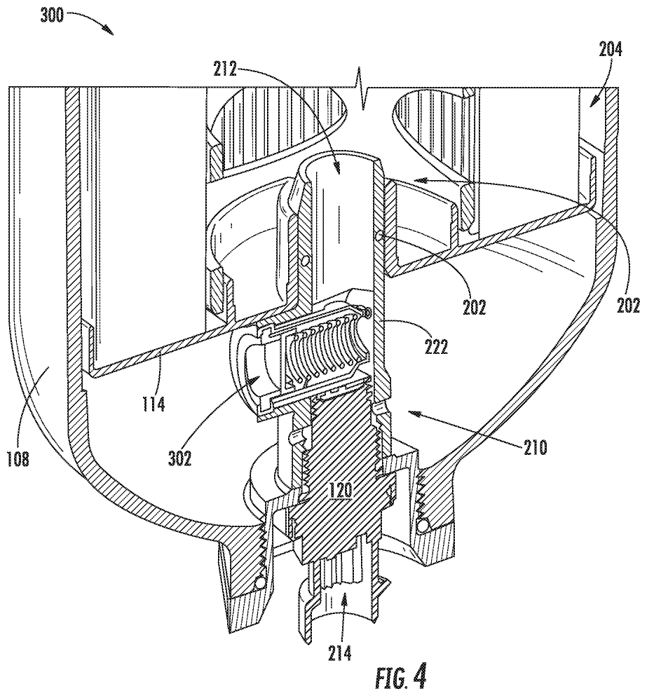

Referring to FIGS. 3 and 4, cross-sectional views of a filtration system 300 are shown according to an example embodiment. The filtration system 300 is similar to the filtration system 100. Accordingly, like numbering is used between FIGS. 1 and 2 and FIGS. 3 and 4 to designate similar parts. The primary difference between the filtration system 300 and the filtration system 100 is that the dP sensor housing 122 of the filtration system 300 includes a bypass valve 302. The bypass valve 302 permits fluid to bypass the filter element 110 in certain operating conditions of the filtration system 300. For example, in arrangements where the filtration system 300 is a lubricant filtration system, the bypass valve 302 may permit oil to bypass the filter element 110 during a cold start condition. As shown in FIG. 4, when the bypass valve 302 is opened, the fluid can flow from the dirty side 204 to the clean side 202 of the filter media 116 through the second opening 212. When the bypass valve 302 is open, the pressure difference between the clean side 202 and the dirty side 204 is substantially reduced than when the bypass valve 302 is closed, and in some cases approaches zero. Accordingly, the feedback from the dP sensor 120 can be monitored to determine when the bypass valve 302 is open (e.g., as indicated by a low dP across the filter element 110) to allow for logging of bypass valve 302 operation.

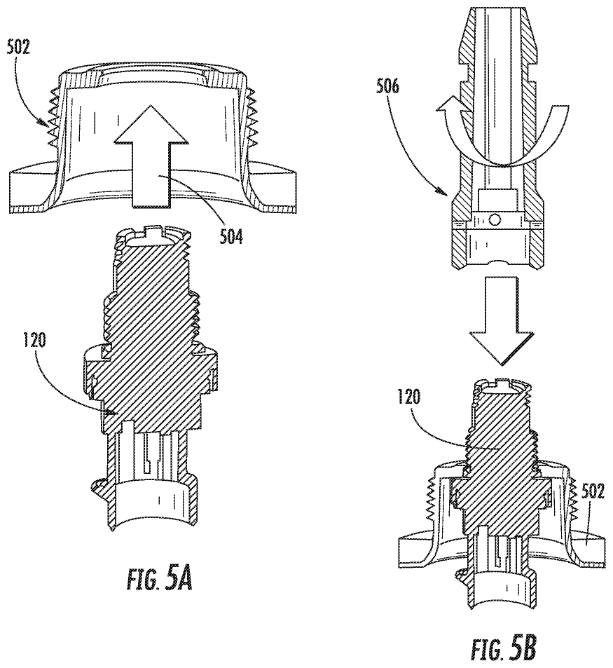

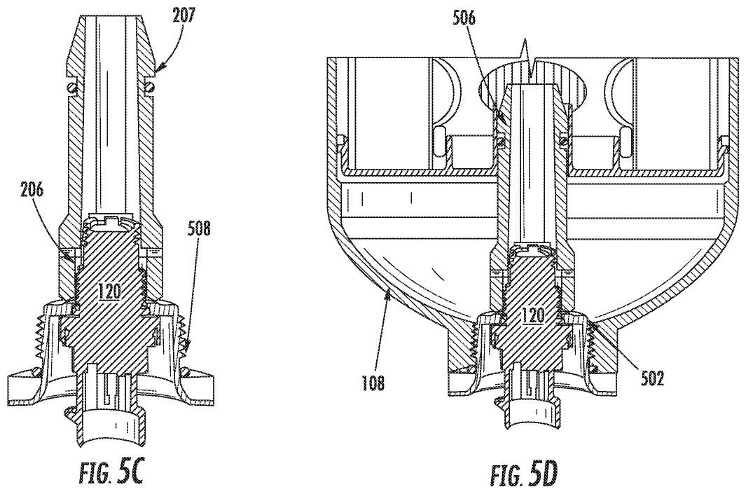

Referring to FIGS. 5A through 5D, cross-sectional views showing the installation of the dP sensor 120 into the filter housing 108 of filtration system 100 or 300 is shown according to an example embodiment. As shown in FIG. 5A, first, the dP sensor 120 is inserted into a lower portion 502 of the dP sensor housing 122. The dP sensor 120 is moved up along arrow 504 and held against the lower portion 502. Next, as shown in FIG. 5B, the upper portion 506 of the housing is inserted over the dP sensor 120. The upper portion 506 is secured to the dP sensor 120 through the threaded connection 206 between the dP sensor 120 and the dP sensor housing 122 (shown in FIG. 5C). Next, as shown in FIG. 5C, the upper seal 207 and the lower seal 508 are installed over the dP sensor housing 122. As discussed above, the upper seal 207 forms a seal between the dP sensor housing 122 and the second endplate 114 of the filter element 110. The lower seal 508 forms a seal between the dP sensor housing 122 and the filter housing 108 as described below with respect to FIG. 5D. After installing the seals 207 and 508, the dP sensor housing assembly formed by the dP sensor 120 and the dP sensor housing 122 is installed on the filter housing 108 via the second threaded connection 208. When the dP sensor housing assembly is installed on the filter housing 108, the dP sensor housing 122 extends into the second endplate 114 of the filter element 110 if the filter element 110 is installed within the filter housing 108. A first seal is created between the dP sensor housing 122 and the second endplate by the upper seal 207. A second seal is created between the dP sensor housing 122 and the filter housing 108 by the lower seal 508. After the dP sensor 120 is fully installed (e.g., as shown in FIG. 5D), the electrical connection between the dP sensor 102 and the ECU can be completed (e.g., by attaching wires between the ECU and the electrical connection 214).

Although described in the context of fuel and lubricant filtration systems, the above-described dP sensor placements within filtration systems can be applied to other types of filtration systems, such as hydraulic fluid filtration systems, coolant filtration systems, water filtration systems, and the like. The above-described dP sensor placements can work with more complex filtration systems that have multiple filtering devices, such as filtration systems having two-stage filter elements, filtration systems having hydrophobic screens (e.g., fuel water separators), filtration systems having stripping mechanisms (e.g., fuel water separators), filtration systems having stacked disc bypasses (e.g., lubricant filtration systems), and the like. Further, although the above-described dP sensor 120 placement is at the bottom of the filter housing 108, the dP sensor 120 can be placed at the top of the filter housing 108 (e.g., coupled to the filter head 102) such that the dP sensor 120 extends through the first endplate 112 of the filter element 110.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems and method steps described herein may be used alone or in combination with other configurations, systems and method steps. It is to be expected that various equivalents, alternatives and modifications are possible.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments, and elements from different embodiments may be combined in a manner understood to one of ordinary skill in the art. Other substitutions, modifications, changes and omissions may also be made in the design, operating conditions and arrangement of the various example embodiments without departing from the scope of the present invention.

1. A filtration system comprising:
a filter head having an inlet and an outlet;
a filter housing removably connected to the filter head and defining a filter compartment;
a filter element positioned in the filter compartment, the filter element having a first endplate, a second endplate, and filter media positioned between the first endplate and the second endplate; and
a pressure differential sensor positioned at a location of the filter housing substantially opposite the filter head, the pressure differential sensor extending into an interior of the filter element.

2. The filtration system of claim 1, further comprising a sensor housing, wherein the pressure differential sensor is received within a cavity of the sensor housing.

3. The filtration system of claim 2, wherein the sensor housing has a first opening on a dirty side of the filter media that is in fluid communication with the pressure differential sensor, and a second opening on a clean side of the filter media that is in fluid communication with the pressure differential sensor.

4. The filtration system of claim 3, wherein the pressure differential sensor senses the pressure difference between the first opening and the second opening.

5. The filtration system of claim 2, wherein the sensor housing includes an externally threaded portion that forms a threaded connection with the bottom of the filter housing.

6. The filtration system of claim 2, wherein the sensor housing extends into the interior of the filter element through an opening in the second endplate, the sensor housing includes a seal that forms a seal between the second endplate and the sensor housing.

7. The filtration system of claim 6, wherein the seal prevents fluid flowing through the filtration system from bypassing the filter media through the opening in the second endplate.

8. The filtration system of claim 2, wherein the sensor housing includes a bypass valve that permits fluid to bypass the filter element when the bypass valve is open.

9. The filtration system of claim 1, wherein the pressure differential sensor comprises first and second pressure sensors.

10. The filtration system of claim 1, wherein the pressure differential sensor is positioned at the bottom of the filter housing.

11. The filtration system of claim 1, wherein the filtration system is a fuel filtration system.

12. The filtration system of claim 1, wherein the filtration system is a lubricant filtration system.

13. A filter element comprising:
a first endplate;
a second endplate displaced from the first endplate, the second endplate having an opening configured to receive a sensor housing and a pressure differential sensor of a filtration system such that the sensor housing extends into the filter element when the filter element is installed in the filtration system;
filter media positioned between the first endplate and the second endplate, the first endplate and the second endplate seal a clean side of the filter media from a dirty side of the filter media; and
a central support tube connecting the first endplate and the second endplate.

14. The filter element of claim 13, wherein the second endplate is configured to form a seal against the sensor housing when the filter element is installed in the filtration system.

15. The filter element of claim 14, wherein the seal prevents fluid flowing through the filtration system from bypassing the filter media through the opening in the second endplate.

16. (canceled)

17. A method comprising:
inserting a sensor into a lower portion of a sensor housing;
providing an upper portion of the sensor housing over the sensor;
installing an upper seal over the upper portion of the sensor housing;
installing the sensor and the sensor housing in the filter housing via a first threaded connection; and
installing a filter element in the filter housing such that the upper portion of the sensor housing extends into the filter element.

18. The method of claim 17, further comprising securing the upper portion of the sensor housing to the lower portion of the sensor housing through a second threaded connection.

19. The method of claim 17, further comprising installing a lower seal over the lower portion of the sensor housing, the lower seal configured to form lower seal between the lower portion of the sensor housing and the filter housing.

20. The method of claim 17, further comprising forming an electrical connection between the sensor and a control unit.
